(19) United States
(12) Patent Application Publication
(10) Pub. No.: US 2026/0074313 A1
(43) Pub. Date: Mar. 12, 2026

(54) SYSTEM AND METHOD FOR PREVENTING REUSE OF BATTERY MONITORING SYSTEM

(71) Applicant: SAMSUNG SDI CO., LTD., Yongin-si (KR)

(72) Inventors: Jong Sam PARK, Yongin-si (KR); Young Shin CHO, Yongin-si (KR); Kyungdo KANG, Yongin-si (KR)

(21) Appl. No.: 19/320,644

(22) Filed: Sep. 5, 2025

(30) Foreign Application Priority Data
Sep. 12, 2024 (KR) 10-2024-0125145

(51) Int. Cl. H01M 10/48; H01M 10/42

(52) U.S. Cl. CPC H01M 10/48; H01M 10/425; H01M 2010/4278; H01M 2220/20

(57) ABSTRACT

Disclosed are a system and method for preventing the reuse of a battery monitoring system (BMS) and a system and method for preventing an unauthenticated private company from reusing a BMS only when a cell is replaced in a battery pack. The system includes a battery monitoring unit configured to monitor specifications of a battery, a cell replacement determination unit configured to determine whether a cell has been replaced in a battery pack based on results of the monitoring of the specifications of the battery, and a permanent failure mode entry unit configured to determine whether to enter into a permanent failure mode for the battery pack based on the results of the determination of whether the cell has been replaced.

### CROSS-REFERENCE TO RELATED APPLICATION

The present application claims priority to and the benefit of Korean Patent Application No. 10-2024-0125145, filed on Sep. 12, 2024, in the Korean Intellectual Property Office, the entire disclosure of which is incorporated herein by reference.

### BACKGROUND

### 1. Technical Field

The present disclosure relates to a system and method for preventing the reuse of a battery monitoring system (BMS). More particularly, the present disclosure relates to a system and method for preventing an unauthenticated private company from reusing a BMS when a cell is replaced in a battery pack.

### 2. Description of Related Art

In certain products, such as vacuum cleaners, mobile phones, and laptops, a counterfeit battery, not a genuine battery, is frequently purchased and used due to the cheaper price of the counterfeit battery. Such counterfeit batteries typically have compatibility issues and have minimal reliability.

In order to reduce the use of counterfeit batteries and provide a safer battery use environment, genuine authentication features have been employed. Genuine authentication are frequently bypassed to reuse a battery monitoring system (BMS) of a battery pack replacing only the cell.

Quality issues arise when the cell is replaced with a cheap cell and the BMS is reused. Furthermore, safety issues arise, such as smoking or firing while using a product, because welding/soldering is not satisfactory between the cell and the BMS.

### SUMMARY

Embodiments of the present disclosure are directed to a system and method for preventing the reuse of a BMS, which determine whether a cell has been replaced through an abnormal path based on cell data stored in the BMS after a battery pack wakes up and prevent the battery pack from being permanently reused.

Embodiments of the present disclosure provide a system for preventing the reuse of a BMS including a battery monitoring unit configured to monitor specifications of a battery, a cell replacement determination unit configured to determine whether a cell has been replaced in a battery pack based on the results of the monitoring of the specifications of the battery, and a permanent failure mode entry unit configured to determine whether to enter into a permanent failure mode for the battery pack based on the results of the determination of whether the cell has been replaced.

Embodiments of the present disclosure provide a system for preventing reuse of a battery monitoring system (BMS), the system including: a battery monitoring unit configured to monitor specifications of a battery; a cell replacement determination unit configured to determine whether a cell has been replaced in a battery pack based monitoring of the specifications of the battery; and a permanent failure mode entry unit configured to determine whether to enter into a permanent failure mode for the battery pack based on determination of whether the cell has been replaced

In some embodiments, the battery monitoring unit may monitor the specifications of the battery including at least any one of the capacity and internal resistance of the battery upon wake-up of the battery pack after shutdown.

In some embodiments, the battery monitoring unit is configured to monitor a capacity of the battery or an internal resistance of the battery, upon wake-up of the battery pack after shutdown.

In some embodiments, the cell replacement determination unit may determine that the cell has been replaced when the capacity of the battery is changed into a maximum reference capacity or more or less than the maximum reference capacity.

In some embodiments, the cell replacement determination unit is configured to determine that the cell has been replaced when the capacity of the battery is changed to equal to or greater than a maximum reference capacity or less than the maximum reference capacity.

In some embodiments, the cell replacement determination unit may determine that the cell has been replaced when the internal resistance is changed into maximum reference resistance or more or less than the maximum reference resistance.

In some embodiments, the cell replacement determination unit is configured to determine that the cell has been replaced when the internal resistance is changed to equal to or greater than a maximum reference resistance or less than the maximum reference resistance.

In some embodiments, the cell replacement determination unit may determine that the cell has been replaced when the capacity of the battery is increased to a reference capacity or more and the internal resistance is increased to reference resistance or more.

In some embodiments, the cell replacement determination unit is configured to determine that the cell has been replaced when the capacity of the battery is increased to equal to or greater than a reference capacity and the internal resistance is increased to equal to or greater than a reference resistance.

In some embodiments, the cell replacement determination unit may determine that the cell has been replaced when the capacity of the battery is decreased to a reference capacity or more and the internal resistance is decreased to a reference resistance or more.

In some embodiments, the cell replacement determination unit is configured to determine that the cell has been replaced when the capacity of the battery is decreased to less than or equal to a reference capacity and the internal resistance is decreased to less than or equal to a reference resistance.

In some embodiments, the cell replacement determination unit may identify an exception condition on the determination of whether the cell has been replaced and prohibits entry into the permanent failure mode, when receiving a communication command related to a reuse of a BMS of the battery pack from a battery pack manufacturer through communication means.

In some embodiments, the cell replacement determination unit is configured to receive an exception condition and prohibit entry into the permanent failure mode.

Embodiments of the present disclosure provide a method of preventing the reuse of a BMS including steps of (a) monitoring specifications of a battery, (b) determining whether a cell has been replaced in a battery pack based on the results of the monitoring in the step (a), and (c) determining to enter into a permanent failure mode based on the results of the determination of whether the cell has been replaced.

Embodiments of the present disclosure provide a method of preventing reuse of a battery monitoring system (BMS), the method including steps of: (a) monitoring specifications of a battery; (b) determining whether a cell has been replaced in a battery pack based on the step (a); and (c) determining whether to enter into a permanent failure mode based on the step (b).

In some embodiments, the step (a) may include monitoring the specifications of the battery including at least any one of a capacity and internal resistance of the battery.

In some embodiments, the step (a) includes monitoring a capacity of the battery or an internal resistance of the battery.

In some embodiments, the step (b) may include determining that the cell has been replaced when a capacity of the battery, among the specifications of the battery, is changed into a maximum reference capacity or more or less than the maximum reference capacity.

In some embodiments, the step (b) includes determining that the cell has been replaced when the capacity of the battery is changed to equal to or greater than a maximum reference capacity or less than the maximum reference capacity.

In some embodiments, the step (b) may include determining that the cell has been replaced when internal resistance of the battery, among the specifications of the battery, is changed into maximum reference resistance or more or less than the maximum reference resistance.

In some embodiments, the step (b) includes determining that the cell has been replaced when the internal resistance of the battery is changed to equal to or greater than maximum reference resistance or less than the maximum reference resistance.

In some embodiments, the step (b) may include determining that the cell has been replaced when a capacity of the battery, among the specifications of the battery, is increased to a reference capacity or more and internal resistance of the battery, among the specifications of the battery, is increased to reference resistance or more.

In some embodiments, the step (b) includes determining that the cell has been replaced when the capacity of the battery is increased to equal to or greater than a reference capacity and the internal resistance of the battery is increased to equal to or greater than a reference resistance.

In some embodiments, the step (b) may include determining that the cell has been replaced when a capacity of the battery, among the specifications of the battery, is decreased to a reference capacity or more and internal resistance of the battery, among the specifications of the battery, is decreased to reference resistance or more.

In some embodiments, the step (b) includes determining that the cell has been replaced when the capacity of the battery is decreased to less than or equal to a reference capacity and the internal resistance of the battery is decreased to less than or equal to a reference resistance.

In some embodiments, the step (c) may include identifying whether an exception condition on the determination of whether the cell has been replaced is satisfied based on at least any one of a cycle count and a runtime and prohibiting the entry into a permanent failure mode.

In some embodiments, the step (c) includes: receiving an exception condition based on a cycle count or a runtime; and prohibiting entry into a permanent failure mode.

Embodiments of the present disclosure provide an apparatus for preventing the reuse of a BMS including an input interface device configured to receive information on the specifications of a battery including at least any one of a capacity and internal resistance of the battery, memory in which a program that may determine a fact that a cell has been replaced by an unauthorized institute based on the information on the specifications of the battery has been stored, and a processor configured to execute the program. The processor may determine the fact that the cell has been replaced based on at least any one reference, including a maximum reference capacity, a reference capacity, maximum reference resistance, and reference resistance.

Embodiments of the present disclosure provide an apparatus for preventing reuse of a battery monitoring system (BMS), the apparatus including: an input interface device configured to receive information on specifications of a battery, the specifications including a capacity of the battery or an internal resistance of the battery; a memory configured to store information related to a program determining whether a cell has been replaced by an unauthorized entity based on the information on the specifications of the battery; and a processor configured to execute the program, wherein the processor is configured to determine whether the cell has been replaced based on a maximum reference capacity, a reference capacity, a maximum reference resistance, or a reference resistance.

In some embodiments, the processor may determine the fact that the cell has been replaced when the capacity of the battery is changed into the maximum reference capacity or more or less than the maximum reference capacity.

In some embodiments, the processor is configured to determine that the cell has been replaced when the capacity of the battery is changed to equal to or greater than the maximum reference capacity or less than the maximum reference capacity.

In some embodiments, the processor may determine the fact that the cell has been replaced when the internal resistance of the battery is changed into the maximum reference resistance or more or less than the maximum reference resistance.

In some embodiments, the processor is configured to determine that the cell has been replaced when the internal resistance of the battery is changed to equal to or greater than the maximum reference resistance or less than the maximum reference resistance.

In some embodiments, the processor may determine the fact that the cell has been replaced when the capacity of the battery is increased to the reference capacity or more and the internal resistance of the battery is increased to the reference resistance or more.

In some embodiments, the processor is configured to determine that the cell has been replaced when the capacity of the battery is increased to equal to or greater than the reference capacity and the internal resistance of the battery is increased to equal to or greater than the reference resistance.

In some embodiments, the processor may determine the fact that the cell has been replaced when the capacity of the battery is decreased to the reference capacity or more and the internal resistance of the battery is decreased to the reference resistance or more.

In some embodiments, the processor is configured to determine that the cell has been replaced when the capacity of the battery is decreased to less than or equal to the reference capacity and the internal resistance of the battery is decreased to less than or equal to the reference resistance.

In some embodiments, the processor may determine to enter into a permanent failure mode based on the results of the determination of the fact that the cell has been replaced, and identifies an entry exception condition on the permanent failure mode by identifying a communication command received from a pack manufacturer.

In some embodiments, the processor is configured to determine to enter into a permanent failure mode based on whether the cell has been replaced, and configured to receive an exception condition on the permanent failure mode.

According to the embodiments of the present disclosure, it is possible to prevent safety features of a battery from being compromised by entering into the permanent failure mode, when a cell has been replaced in a battery pack and the setting of the cell is not compatible with a protection operation of the BMS of the battery pack, such as when a cell has been replaced with a cell the current of which has been permitted up to only about 10 A wherein over-current protection for the BMS is set about 15 A, for example, is identified.

According to the embodiments of the present disclosure, it is possible to encourage the use of a battery pack that is developed by a manufacturer, by allowing the BMS of the battery pack to be reused only by the manufacturer or a company authorized by the manufacturer.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 schematically illustrates an electrode assembly of a secondary battery according to embodiments of the present disclosure.

FIG. 2 schematically illustrates a configuration of a pouch-type secondary battery according to embodiments of the present disclosure.

FIG. 3 illustrates a schematic external appearance configuration of a prismatic secondary battery according to embodiments of the present disclosure.

FIG. 4 is a cross-sectional view of a cylindrical secondary battery according to embodiments of the present disclosure.

FIG. 5 illustrates a system for preventing the reuse of a BMS according to embodiments of the present disclosure.

FIG. 6 illustrates a method of preventing the reuse of a BMS according to embodiments of the present disclosure.

FIG. 7 illustrates a detailed sequence of a method of preventing the reuse of a BMS according to embodiments of the present disclosure.

FIG. 8 is a block diagram illustrating a computer system for implementing a method according to embodiments of the present disclosure.

FIG. 9 illustrates a secondary battery module in which secondary batteries manufactured according to embodiments of the present disclosure are arranged;

FIG. 10 illustrates a secondary battery pack including the secondary battery module illustrated in FIG. 10; and

FIG. 11 is a conceptual view of a vehicle including the secondary battery pack illustrated in FIG. 10.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the aspects of the present disclosure. Accordingly, it should be understood that there may be various equivalents and modifications that can replace or modify one or more example embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges is within the scope of this invention.

References to two compared elements, features, etc. As being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

The terminology used herein is for the purpose of describing embodiments of the present disclosure and is not intended to limit the present disclosure.

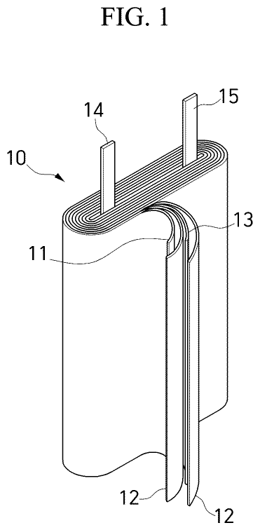

FIG. 1 schematically illustrates an electrode assembly built in a case of a secondary battery.

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction (e.g., the y direction) of the case 59. In some embodiments, the electrode assembly 10 may be a stack type rather than a winding type, and the geometry of the electrode assembly 10 is not limited to the embodiments of the present disclosure. The electrode assembly 10 may be or include a Z-stack electrode assembly in which a positive electrode plate and a negative electrode plate are inserted into both sides of a separator, which is then bent into a Z-stack. One or more electrode assemblies may be stacked such that long sides of the electrode assemblies are adjacent to each other and accommodated in the case. The number of electrode assemblies in the case is not limited to the embodiments of the present disclosure. The first electrode plate 11 of the electrode assembly may act as a negative electrode, and the second electrode plate 13 may act as a positive electrode. The first electrode plate 11 of the electrode assembly may act as a positive electrode, and the second electrode plate 13 may act as a negative electrode.

The first electrode plate 11 may be formed by applying a first electrode active material, such as graphite or carbon, to a first electrode current collector formed of or including a metal foil, including copper, a copper alloy, nickel, or a nickel alloy. The first electrode tab 14 may be connected to an external first terminal (not shown). In some embodiments, the first electrode tab 14 may be formed by being cut in advance to protrude to one side of the electrode assembly 10, or the first electrode tab 14 may protrude to one side of the electrode assembly 10 more than, e.g., farther than or beyond, the separator 12 without being separately cut.

The second electrode plate 13 may be formed by applying a second electrode active material, such as a transition metal oxide, on a second electrode current collector formed of or including a metal foil, including aluminum or an aluminum alloy. The second electrode plate 13 may include a second electrode tab 15 (e.g., a second uncoated portion) that is or includes a region to which the second electrode active material is not applied. The second electrode tab 15 may be connected to an external second terminal (not shown). In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than, e.g., farther than or beyond, the separator 12 without being separately cut.

In some embodiments, the first electrode tab 14 may be located on the left hand side of the electrode assembly 10, and the second electrode tab 15 may be located on the right hand side of the electrode assembly 10. In some embodiments, the first electrode tab 14 and the second electrode tab 15 may be located on one side of the electrode assembly 10 in the same direction.

For convenience of description, the left hand side and right hand side are defined according to the electrode assembly 10 as oriented in FIG. 1, and the positions thereof may change when the secondary battery is rotated left and right or up and down.

The separator 12 hinders or substantially prevents a short-circuit between the first electrode 11 and the second electrode 13 while allowing movement of lithium ions therebetween. The separator 12 may be made of or include, for example, a polyethylene film, a polypropylene film, or a polyethylene-polypropylene film.

In some embodiments, the electrode assembly 10 may be accommodated in the case (not shown) along with an electrolyte. For a pouch-type secondary battery, an electrode assembly 10 may be accommodated in a pouch made of or including flexible material in the form illustrated in FIG. 1. For a prismatic secondary battery, an electrode assembly 10 may be accommodated in a prismatic metal casing in the form illustrated in FIG. 1.

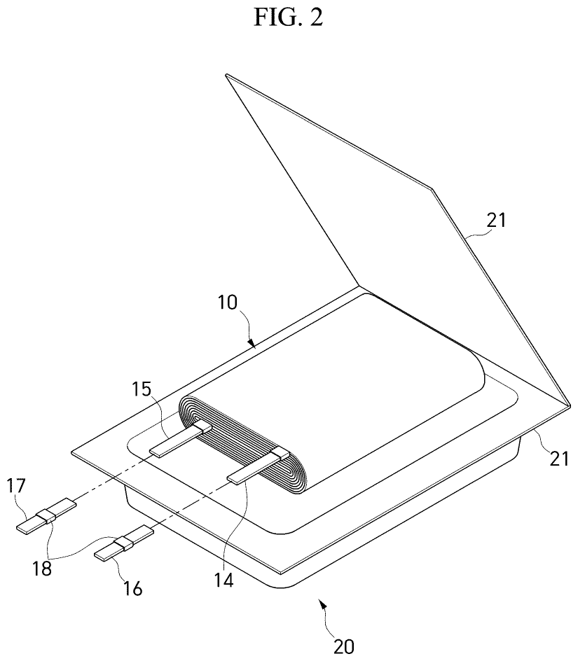

FIG. 2 schematically illustrates the pouch-type secondary battery.

The pouch-type secondary battery includes an electrode assembly 10 and a pouch 20 that accommodates or contains the electrode assembly 10 therein.

The electrode assembly 10 may be substantially the same as the electrode assembly 10 illustrated in FIG. 1. The first electrode tab 14 and the second electrode tab 15 of the electrode assembly 10 may be electrically connected to external first and second terminal leads 16 and 17, respectively, by, e.g., welding or other attaching method that preserves conductivity therebetween. At least a portion of each of the first terminal lead 16 and the second terminal lead 17 may be attached or covered with a tab film 18 for insulation from the pouch 20.

The pouch 20 may be sealed by having sealing parts 21 at the edges thereof come into contact with each other while accommodating or containing the electrode assembly 10 therein. The sealing may be achieved with the tab film 18 interposed between the sealing parts 21. The sealing parts 21 of the pouch 20 may be made of or include a thermal fusion material that generally has weak adhesion to metal. The sealing parts 21 may be fused to the pouch 20 by interposing the thin tab film 18 between the sealing parts 21.

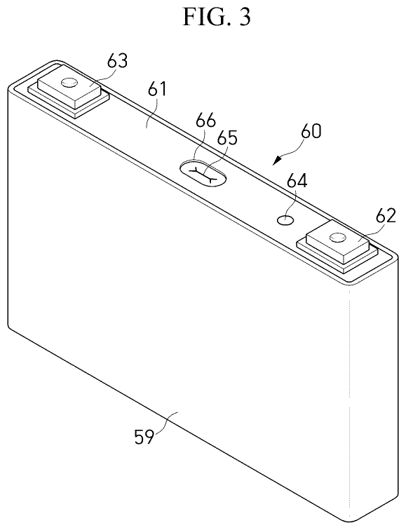

FIG. 3 illustrates a schematic external appearance configuration of a prismatic secondary battery.

A prismatic case 59 defines an overall appearance of the prismatic secondary battery, and may be made of or include a conductive metal, such as aluminum, aluminum alloy, or nickel-plated steel. The case 59 may accommodate or contain the electrode assembly 10 therein.

A cap assembly 60 may include a cap plate 61 that covers an opening of the case 59. The case 59 and the cap plate 61 may be made of or include a conductive material. A first terminal 63 and a second terminal 62 may be electrically connected to the first electrode tab 14 and the second electrode tab 15, respectively, of the electrode assembly 10 illustrated in FIGS. 1 and 2 inside the case 59, and may be installed to protrude outward through the cap plate 61.

The cap plate 61 may be equipped with or include an electrolyte injection port 64 configured to install a sealing plug therein, and a vent 66 including a notch 65 may be installed. The vent 66 is configured to discharge any gas generated within the secondary battery.

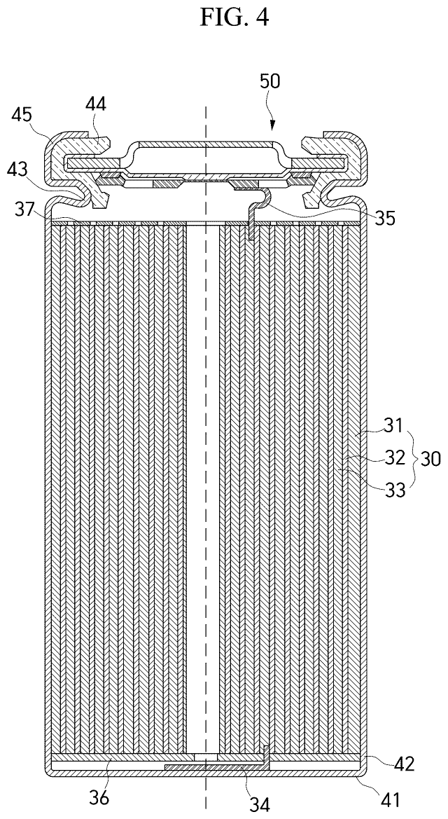

FIG. 4 is a cross-sectional view of a cylindrical secondary battery.

The cylindrical secondary battery includes an electrode assembly 30, a case accommodating the electrode assembly 30 and an electrolyte contained therein, a cap assembly 50 coupled to an opening of the case to seal the case, and an insulating plate 37 located between the electrode assembly 30 and the cap assembly 50 within the case.

The electrode assembly 30 may include a separator 32 between a first electrode 33 and a second electrode 31, and the electrode assembly 30 may be wound in a jelly-roll form.

The first electrode 33 may include a first substrate and a first active material layer located on the first substrate. A first lead tab 35 may extend outward from a first uncoated portion of the first substrate where the first active material layer is not located, and may be electrically connected to the cap assembly 50.

The second electrode 31 may include a second substrate and a second active material layer located on the second substrate. A second lead tab 34 may extend outward from a second uncoated portion of the second substrate where the second active material layer is not located, and may be electrically connected to the case. The first lead tab 35 and the second lead tab 34 may extend in opposite directions with respect to each other.

The first electrode 33 may correspond to a positive electrode. The first substrate may be composed of or include, for example, aluminum foil, and the first active material layer may include, for example, a transition metal oxide. The second electrode 31 may correspond to a negative electrode. The second substrate may be composed of or include, for example, copper foil or nickel foil, and the second active material layer may include, for example, graphite.

The separator 32 may reduce the chance of or prevent a short-circuit between the first electrode 33 and the second electrode 31 while allowing movement of lithium ions therebetween. The separator 32 may be made of or include, for example, at least one of a polyethylene film, a polypropylene film, or a polyethylene-polypropylene film.

The case accommodates or contains the electrode assembly 30 and the electrolyte, and substantially forms the external appearance of the secondary battery together with the cap assembly 50. The case may have a substantially cylindrical body portion 42, and a bottom portion 41 connected to one side of the body portion 42. A beading part 43 deformed inwardly may be formed in the body portion 42, and a crimping part 45 bent inwardly may be formed at an open end of the body portion 42.

The beading part 43 may reduce or prevent movement of the electrode assembly 30 inside the case, and may facilitate seating of a gasket 44 and the cap assembly 50. A crimping part 45 may firmly fix the cap assembly 50 by pressing the edge of the cap assembly 50 against the gasket 44. The case may be formed of or include iron plated with nickel, for example.

The cap assembly 50 may be fixed to the interior of the crimping part 45 through the gasket 44 to seal the case. The cap assembly 50 may include a cap up, a safety vent, a cap down, an insulating member, and a subplate, but is not limited to this embodiment and may be variously modified.

The cap up may be located at the very top of the cap assembly 50. The cap up may include a terminal portion that protrudes convexly upward and is connected to an external circuit, and an outlet for discharging gas may be located around the terminal portion.

The safety vent may be located below the cap up. The safety vent may include a protrusion that protrudes convexly downward and is connected to the subplate, and at least one notch located around the protrusion.

When internal gas is generated due to overcharging or abnormal operation of the secondary battery, the protrusion may be deformed upward by pressure and may separate from the subplate, while the safety vent may be cut along the notch. The cut safety vent may hinder or prevent the secondary battery from exploding by discharging gas to the outside.

The cap down may be located below the safety vent. The cap down may be formed with a first opening for exposing the protrusion of the safety vent and a second opening for discharging gas. The insulating member may be located between the safety vent and the cap down to insulate the safety vent and the cap down.

The subplate may be located below the cap down. The subplate may be fixed to a lower surface of the cap down to block the first opening of the cap down, and the protrusion of the safety vent may be fixed to the subplate. The first lead tab 35 pulled out from the electrode assembly 30 may be fixed to the subplate. Accordingly, the cap up, the safety vent, the cap down, and the subplate may be electrically connected to the first electrode 33 of the electrode assembly 30.

The insulating plate 37 may be located below the beading portion 43 to be in contact with the electrode assembly 30, and may be provided with a tab opening for pulling out the first lead tab 35. The cap assembly 50, which is electrically connected to the first electrode 33 by the first lead tab 35, may face the electrode assembly 30 with the insulating plate 37 interposed therebetween, and may maintain an insulated state from the electrode assembly 30 by the insulating plate 37. Another insulating plate 36 may be included for insulation between the electrode assembly 30 and the bottom portion 41 of the case.

Safety issues arise when a cell is replaced in a battery pack by an unauthorized entity and the BMS of the battery pack is reused. When a cell is replaced during operation of a battery pack, the battery pack may enter into a permanent failure mode because a cell imbalance or a low voltage failure may be detected. When only a cell is replaced in a battery back when the battery pack has been shut down, it may be difficult to detect whether the cell has been replaced.

According to embodiments of the present disclosure, it is possible to prevent such safety issues, such as smoking or firing, by preventing a battery pack from being permanently used, by analyzing cell data stored in the BMS of the battery pack after the battery pack wakes up and to enter into the permanent failure mode when it is determined that the cell has been replaced through the abnormal path by an unauthorized entity.

According to embodiments of the present disclosure, the unauthorized reuse of a BMS is controlled to avoid entering into the permanent failure mode by putting an exception condition pursuant to a determination of whether a cell has been replaced for the purpose of the reuse of the BMS of a battery pack by an authenticated institute or tests are performed during development by the manufacturer.

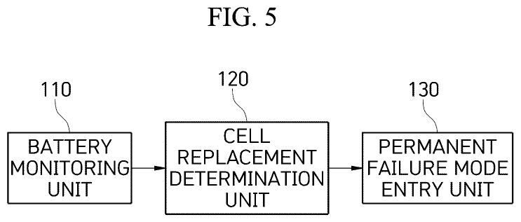

FIG. 5 illustrates a construction of a system for preventing the reuse of a BMS.

According to embodiments of the present disclosure, whether a cell of a battery has been replaced may be determined by monitoring the specifications of the battery for at least any one of the capacity and internal resistance of the battery. When monitoring the capacity, cell replacement can be determined if the capacity of the battery has been changed equal to or greater than a maximum reference capacity or less than the maximum reference capacity. When monitoring the internal resistance, cell replacement can be determined if the internal resistance has been changed equal to or greater than a maximum reference resistance or less than the maximum reference resistance. If the capacity of the battery is changed to equal to or greater than a reference capacity or less than the reference capacity and the internal resistance of the battery is changed to equal to or greater than a reference capacity or less than the reference capacity, it may be determined that the cell has been replaced.

The system for preventing the reuse of a BMS may include a battery monitoring unit 110 that monitors the specifications of a battery, a cell replacement determination unit 120 that determines whether a cell has been replaced in a battery pack based on the results of the monitoring of the specifications of the battery, and a permanent failure mode entry unit 130 that enters into the permanent failure mode if the cell has been replaced by an unauthorized entity.

The capacity of a battery may be decreased as the cell degrades, and internal resistance of the cell may be increased as the capacity of the cell decreases. Although an actual cell replacement does not take place, capacity increase or internal resistance decrease can be detected due to a measuring error or use environment (e.g., a temperature) of the BMS of the battery pack.

When a cell of a battery is replaced and a battery pack wakes up while the battery pack has been shut down, the BMS of the battery pack may not detect whether the cell has been replaced. In contrast, according to embodiments of the present disclosure, the BMS of a battery pack may determine whether a cell of a battery has been replaced by monitoring the specifications of the battery including at least any one of the capacity and internal resistance of the battery, both of which can be monitored as the battery performs charging or discharging. The cell replacement determination unit 120 may analyze the results of the monitoring, and may determine whether the cell has been replaced.

In order to prevent false detection of cell replacement, the cell replacement determination unit 120 may perform a determination of whether the cell has been replaced from wake-up until any variation of the capacity of a battery is detected, and may not perform a determination of whether the cell has been replaced from any variation of the capacity of a battery is detected.

The cell replacement determination unit 120 may not perform cell replacement determination until a battery warranty period is expired. For example, when a cycle count is equal to or less than a reference (e.g., 50 cycles), the cell replacement determination unit 120 does not enter into the permanent failure mode. The cell replacement determination unit 120 does not enter into the permanent failure mode when a run time is less than or equal to a reference (e.g., 180 days).

The cell replacement determination unit 120 may receive a communication command generated by a battery pack manufacturer and may not enter into permanent failure mode when the communication command is received if a BMS is intended to be reused, that is, the BMS is intentionally reused by an authenticated entity or tests are performed on the BMS for reuse. The communication command may not be public, and may be used to identify that an exception condition related to a cell replacement determination only when a key value is matched. Such a key value is a predetermined value, and may be confidential information known to the manufacturer.

The cell replacement determination unit 120 may determine cell replacement in a battery pack when a certain criterion has been met. The permanent failure mode entry unit 130 may enter into the permanent failure mode for a battery pack based on a cell replacement determination by the cell replacement determination unit 120 unless an exception condition occurs.

The cell replacement determination unit 120 may determine that a cell has been replaced in a battery pack when the capacity of a battery is changed equal to or greater than a maximum reference capacity or less than the maximum reference capacity. The cell replacement determination unit 120 may determine that a cell has been replaced when the sensed capacity of a battery is increased to equal to or greater than a maximum reference capacity (e.g., about 1000 mAh). For example, the capacity of the battery may be increased to about 1500 mAh after wake-up of the battery pack, compared to the capacity of the battery when the battery pack is shut down. The permanent failure mode entry unit 130 may enter into the permanent failure mode based on the results of the determination of the cell replacement determination unit 120 as the capacity of the battery reaches or exceeds the maximum reference capacity.

The cell replacement determination unit 120 may determine that a cell has been replaced in a battery pack when internal resistance of the cell is changed to a value beyond a maximum reference resistance range (compared to the internal resistance of the cell when the battery pack is shut down). The cell replacement determination unit 120 may determine that a cell has been replaced when the sensed internal resistance of the cell is decreased to beyond a maximum reference resistance range (e.g., about 10 milliohm). For example, the internal resistance of the cell is decreased to about 10 milliohm after wake-up of a battery pack, compared to internal resistance of the cell when the battery pack is shut down. The permanent failure mode entry unit 130 may enter into the permanent failure mode based on the results of the determination of the cell replacement determination unit 120 as the internal resistance of the cell reduces to a value beyond the maximum reference resistance range (compared to internal resistance of the cell when the battery pack is shut down).

The cell replacement determination unit 120 may determine that a cell has been replaced in a battery pack when the capacity of a battery is increased to equal to or greater than a reference capacity and internal resistance of the cell is increased to equal to or greater than a reference resistance. The cell replacement determination unit 120 may determine that a cell has been replaced when the capacity of a battery is increased to equal to or greater than a reference capacity (e.g., about 300 mAh) and the internal resistance of the cell is increased to equal to or greater than a reference resistance (e.g., about 1 milliohm) after wake-up of a battery pack. For example, the capacity of the battery may be increased to about 400 mAh and the internal resistance of the cell may be increased to about 1.3 milliohm after wake-up, compared when the battery pack is shut down.

The cell replacement determination unit 120 may determine that a cell has been replaced in a battery pack when the capacity of a battery is decreased to less than or equal to a reference capacity and the internal resistance of the cell is decreased to less than or equal to a reference resistance. The cell replacement determination unit 120 may determine that a cell has been replaced when the capacity of a battery is decreased to less than or equal to a reference capacity range (e.g., about 300 mAh) (compared to capacity of the cell when the battery pack is shut down) and the internal resistance of the cell is decreased to a value beyond a reference resistance range (e.g., about 1 milliohm) after the wake-up of a battery pack.

According to embodiments of the present disclosure, in similar types of cells, an internal resistance value of a battery may be increased as deterioration progresses. In different types of cells, whether a cell has been replaced in a battery pack may be determined by considering a maximum reference capacity, a maximum reference resistance, a reference capacity, and/or a reference resistance, because the capacities and resistance of the cells cannot be compared by absolute numerical values.

As used herein, the term “maximum reference capacity” refers to the highest capacity value, determined as a reference, among the cells of the same type when they are in a non-degraded, initial state. This value is used as a benchmark for comparing the capacity of other cells in the battery pack.

As used herein, the term “maximum reference resistance” refers to the highest internal resistance value, determined as a reference, among the cells of the same type when they are in a non-degraded, initial state. This value is used as a benchmark for comparing the resistance of other cells in the battery pack.

As used herein, the term “reference capacity” refers to a capacity value, determined as a threshold or baseline, for each cell or cell type, which may be set based on a predetermined percentage of the maximum reference capacity or derived from empirical data. This value is used to assess the degradation state or replacement need of the cell.

As used herein, the term “reference resistance” refers to an internal resistance value, determined as a threshold or baseline, for each cell or cell type, which may be set based on a predetermined percentage or increment from the maximum reference resistance or derived from empirical data. This value is used to assess the degradation state or replacement need of the cell.

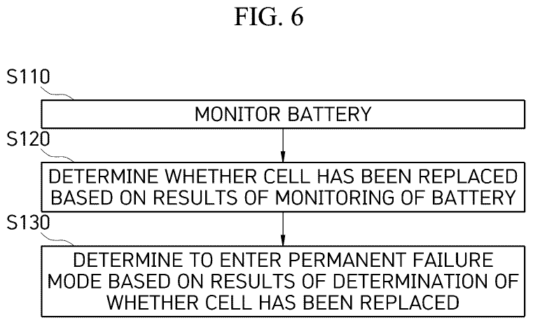

FIG. 6 illustrates a method of preventing the reuse of a BMS.

The method of preventing the reuse of a BMS may include step S110 of monitoring the specifications of a battery, step S120 of determining whether a cell has been replaced in a battery pack based on the results of the monitoring of the specifications of the battery in step S110, and step S130 of entering the permanent failure mode based on the results of the determination of whether the cell has been replaced.

In step S110, the specifications of a battery including at least any one of the capacity of the battery and the internal resistance of a cell thereof may be monitored. In step S120, the results of the monitoring of the specifications of the battery and whether the cell has been replaced may be determined based on at least any one of a maximum reference capacity, a maximum reference resistance, a reference capacity, and/or a reference resistance.

In step S120, in order to prevent false detection for whether the cell has been replaced, the determination of whether the cell has been replaced may be performed from wake-up until any variation of the capacity of the battery is detected, and may not be performed from any variation of the capacity is detected. In step S120, if a battery warranty period is not expired, the determination of whether the cell has been replaced may not be performed, and permanent failure mode may not be entered into. When a cycle count is less than or equal to a reference (e.g., about 50 cycles) or when a run time is less than or equal to a reference (e.g., about 180 days), the determination of whether the cell has been replaced may not be performed, and the permanent failure mode may not be entered into.

In step S120, an exception situation, in which the permanent failure mode is not entered into, may be determined by receiving and identifying a communication command generated by a battery pack manufacturer indicating that a BMS is to be intentionally reused by an authenticated entity or that tests are performed. The communication command is information that may be only known to the manufacturer and may not be public. An exception condition is satisfied only when a key value is matched.

In step S120, whether the cell has been replaced in the battery pack may be determined when a certain criterion for the determination of whether the cell has been replaced has been met. In step S130, the battery pack may enter into permanent failure mode based on the results of the determination in step S120 unless the exception condition (e.g., when the reuse of the BMS is intentional by the manufacturer) is satisfied.

In step S120, when the capacity of the battery is increased to equal to or greater than a maximum reference capacity, it may be determined that the cell has been replaced in the battery pack. It may be determined that the cell has been replaced when the sensed capacity of the battery is increased to equal to or greater than a maximum reference capacity (e.g., about 1000 mAh), for example, when the capacity of the battery is increased to about 1500 mAh after wake-up of the battery pack, compared to the capacity of the battery when the battery pack is shut down. In step S130, the permanent failure mode may be entered into based the results of the determination of whether the cell has been replaced according to the increase of the capacity of the battery in step S120.

In step S120, when internal resistance of the cell is decreased to beyond a maximum reference resistance range (compared to internal resistance of the cell when the battery pack is shut down), it may be determined that the cell has been replaced in the battery pack. It may be determined that the cell has been replaced when the sensed internal resistance of the cell is decreased to beyond a maximum reference resistance range (compared to internal resistance of the cell when the battery pack is shut down) (e.g., about 10 milliohm), for example, when the internal resistance of the cell is decreased to beyond a range (e.g., about 10 milliohm), compared to internal resistance of the cell when the battery pack is shut down, compared to internal resistance of the cell when the battery pack is shut down. In step S130, the permanent failure mode may be entered into based on the results of the determination of whether the cell has been replaced according to the decrease of the internal resistance of the cell in step S120.

In step S120, it may be determined that the cell has been replaced in the battery pack when the capacity of the battery is increased to equal to or greater than a reference capacity and the internal resistance of the cell is increased to equal to or greater than a reference resistance range. It may be determined that the cell has been replaced when the capacity of the battery is increased to equal to or greater than a reference capacity range (e.g., about 300 mAh) and the internal resistance of the cell is increased to equal to or greater than a reference resistance range (e.g., about 1 milliohm) (compared to internal resistance of the cell when the battery pack is shut down) after wake-up of the battery pack, for example, when the capacity of the battery is increased to beyond a range (e.g., about 400 mAh) and the internal resistance of the cell is increased to beyond a range (e.g., about 1.3 milliohm) after the wake-up, compared to when the battery pack is shut down. In step S130, the permanent failure mode may be entered into based on the results of the determination of whether the cell has been replaced according to the increase of the capacity of the battery and the increase of the internal resistance of the cell in step S120.

In step S120, it may be determined that the cell has been replaced in the battery pack when the capacity of the battery is decreased to beyond a reference capacity range and internal resistance of the cell is decreased to beyond a reference resistance range. It may be determined that the cell has been replaced when the capacity of the battery is increased to a value outside to a reference capacity range (e.g., about 300 mAh) or more and the internal resistance of the cell is decreased to a value beyond the reference resistance range (e.g., about 1 milliohm) (compared to internal resistance of the cell before wakeup) or more after the wake-up of the battery pack, that is, the capacity of the battery is decreased to a value beyond a range (e.g., about 400 mAh) (compared to internal resistance of the cell before wakeup), but the internal resistance of the cell is decreased more than about 1.3 milliohm after the wake-up, compared to timing at which the battery pack is shut down. In step S130, the permanent failure mode may be entered into based on the results of the determination of whether the cell has been replaced according to the decrease of the capacity of the battery and the decrease of the internal resistance of the cell in step S120.

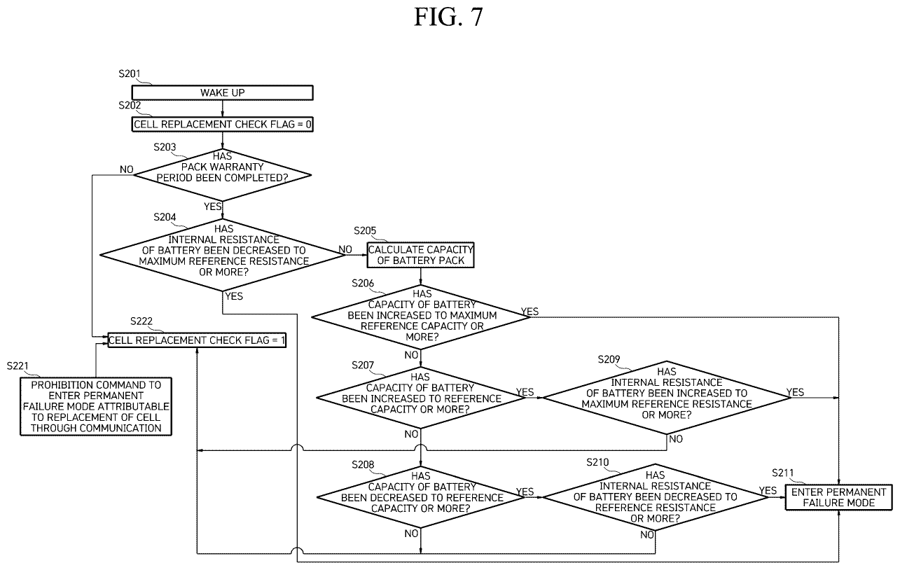

FIG. 7 illustrates a detailed sequence of a method of preventing the reuse of a BMS according to embodiments of the present disclosure.

In step S201, a battery pack may wake up.

In step S202, a cell replacement check flag may be designated as 0.

In step S203, it may be identified whether a pack warranty period has been expired. In order to prevent false detection of cell replacement, when the battery warranty period is not expired, a determination of whether the cell has been replaced may not be performed, and the cell replacement check flag may be designated as 1 in step S222. In step S203, whether a cycle count is less than or equal to a reference (e.g., about 50 cycles) may be considered. Alternatively, in step S203, whether a runtime is less than or equal to a reference (e.g., about 180 days) may be considered.

As an exception condition related to the cell replacement determination occurs, in step S221, when a permanent failure mode entry prohibition command attributable to the replacement of the cell is received through communication, the cell replacement may be designated as 1, and the permanent failure mode may not be entered into. If a BMS is intentionally reused by an authenticated entity or tests are performed on the BMS, the permanent failure mode may not be entered into when a communication command generated by a battery pack manufacturer is received.

When it is identified that the pack warranty period has been expired in step S203, it is identified in step S204 whether internal resistance of the battery has been changed to equal to or greater than a maximum reference resistance or less than the maximum reference resistance (FIG. 7 illustrates identifying whether the internal resistance of the battery has been decreased to a value beyond a maximum reference resistance range).

When it is identified that the internal resistance of the battery has been decreased to a value beyond the maximum reference resistance range in step S204, it may be determined that the cell has been replaced in the battery pack. In step S211, the permanent failure mode may be entered into. It may be determined that the cell has been replaced when sensed internal resistance of the cell is decreased to beyond a maximum reference resistance range (e.g., about 10 milliohm) (compared to internal resistance of the cell when the battery pack is shut down) or more, for example, when the internal resistance of the cell is decreased to by more than about 10 milliohm after wake-up of the battery pack, compared to the internal resistance of the cell when the battery pack is shut down, the permanent failure mode may be entered into.

When it is identified that the internal resistance of the battery has not been decreased beyond the maximum reference resistance range in step S204, the calculation of a pack capacity may be performed in step S205.

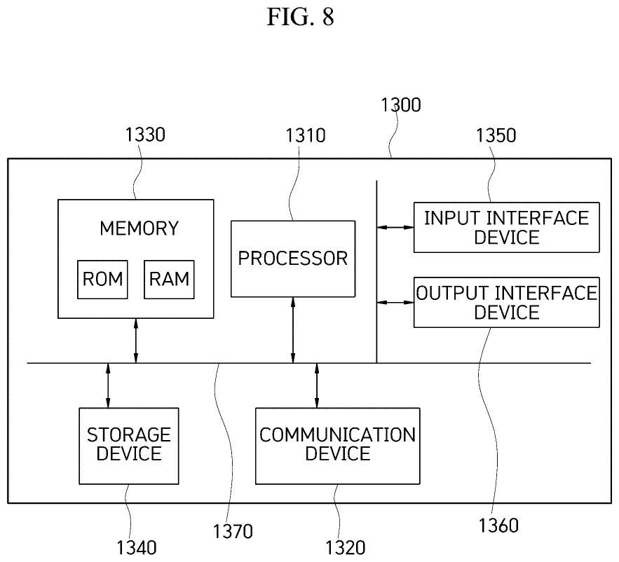

In step S206, it is identified whether the capacity of the battery pack has been changed to equal to or greater than a maximum reference capacity or less the maximum reference capacity (FIG. 8 illustrates whether the capacity of the battery pack has been increased to equal to or greater than a maximum reference capacity).

When it is identified that the capacity of the battery pack has been increased to equal to or greater than the maximum reference capacity in step S206, the permanent failure mode may be entered into in step S211. It may be determined that the cell has been replaced when the sensed capacity of the battery is increased to equal to or greater than a maximum reference capacity (e.g., about 1000 mAh), for example, when the capacity of the battery is increased to about 1500 mAh after the wake-up of the battery pack, compared to the capacity of the battery when the battery pack is shut down, and the permanent failure mode may be entered into.

When it is identified that the capacity of the battery pack has not been increased to equal to or greater than the maximum reference capacity in step S206, in step S207, it is identified whether the capacity of the battery pack has been increased to equal to or greater than a reference capacity. When it is identified that the capacity of the battery pack has been increased to equal to or greater than the reference capacity in step S207, whether internal resistance of the battery has been increased to equal to or greater than the reference resistance is identified in step S209.

When it is identified that the capacity of the battery has been increased to equal to or greater than the reference capacity and the internal resistance of the battery has been increased to equal to or greater than the reference resistance, in step S211, the permanent failure mode may be entered into. It may be determined that the cell has been replaced when the capacity of the battery is increased to equal to or greater than a reference capacity (e.g., about 300 mAh) and the internal resistance of the cell is increased to equal to or greater than a reference resistance (e.g., about 1 milliohm) after the wake-up of the battery pack, for example, when the capacity of the battery is increased by more than about 400 mAh and the internal resistance of the cell is increased by more than about 1.3 milliohm after wake-up, compared to when the battery pack is shut down, and the permanent failure mode may be entered into.

When it is identified that the capacity of the battery pack has not been increased to equal to or greater than the reference capacity in step S207, whether the capacity of the battery pack has been decreased to less than or equal to the reference capacity is identified in step S208. When it is identified that the capacity of the battery pack has been decreased to less than or equal to the reference capacity in step S208, whether the internal resistance of the battery has been decreased to less than or equal to the reference resistance is identified in step S210.

When it is identified that the capacity of the battery has been decreased to less than or equal to the reference capacity and the internal resistance of the battery has been decreased to less than or equal to the reference resistance, in step S211, the permanent failure mode may be entered into. It may be determined that the cell has been replaced when the capacity of the battery is increased to a reference capacity range (e.g., about 300 mAh) or more and the internal resistance of the cell is decreased to a value beyond a reference resistance range (e.g., about 1 milliohm) (compared to before wakeup) or more after the wake-up of the battery pack, that is, the capacity of the battery is decreased to about 400 mAh, but the internal resistance of the cell is decreased to about 1.3 milliohm without being increased after the wake-up, compared to when the battery pack is shut down, and the permanent failure mode may be entered into.

FIG. 8 is a block diagram illustrating a computer system for implementing the method.

Referring to FIG. 8, the computer system 1300 may include at least one of a processor 1310, a memory 1330, an input interface device 1350, an output interface device 1360, and a storage device 1340 communicating with one another through a bus 1370. The computer system 1300 may also include a communication device 1320 coupled to a network. The processor 1310 may be or include a central processing unit (CPU) or a semiconductor device that executes instructions stored in the memory 1330 or in the storage device 1340. The memory 1330 and the storage device 1340 may include various types of volatile or nonvolatile storage media. For example, the memory may include a read-only memory (ROM) and a random access memory (RAM). In some embodiments, the memory may be located inside or outside the processor, and may be connected to the processor through various known means. The memory is or includes various types of volatile or nonvolatile storage media, and for example, may include a read-only memory (ROM) or a random access memory (RAM).

Accordingly, embodiments of the present disclosure may be implemented as a method implemented in a computer or a non-transitory computer-readable medium storing computer-executable instructions. In an embodiment, when executed by the processor, computer-readable instructions may perform a method according to at least one aspect of the present disclosure.

The communication device 1320 may transmit or receive wired signals or wireless signals.

The apparatus for preventing the reuse of a BMS may include an input interface device 1350 that receives information on the specifications of a battery including at least any one of the capacity and internal resistance of the battery, memory 1330 in which a program that determines the fact that a cell has been replaced by an unauthorized institute has been stored based on the information on the specifications of the battery, and the processor 1310 that execute the program. The processor 1310 may determine the fact that a cell has been replaced based on at least any one of references including a maximum reference capacity, a reference capacity, maximum reference resistance, and/or a reference resistance.

The processor 1310 may determine whether a cell has been replaced when the capacity of a battery is changed to equal to or greater than a maximum reference capacity or less than the maximum reference capacity.

The processor 1310 may determine whether a cell has been replaced when internal resistance of the battery is changed to equal to or greater than maximum reference resistance or less than the maximum reference resistance.

The processor 1310 may determine whether the cell has been replaced when the capacity of a battery is increased to equal to or greater than a reference capacity and the internal resistance of the battery is increased to equal to or greater than a reference resistance.

The processor 1310 may determine whether a cell has been replaced when the capacity of a battery is decreased to less than or equal to a reference capacity and the internal resistance of the battery is decreased to less than or equal to a reference resistance.

The processor 1310 may determine to enter into permanent failure mode based on the results of a determination of the fact that a cell has been replaced, and may identify an exception condition by receiving a communication command from a pack manufacturer.

The method may be implemented in the form of program instructions that can be executed through various computer means and recorded on a computer-readable medium.

The computer-readable medium may include program instructions, data files, data structures, etc., singly or in combination. The program instructions recorded on the computer-readable medium may be specially designed and configured for the example embodiments of the present disclosure, or may be known and usable by those skilled in the art of computer software. Computer-readable recording media may include a hardware device configured to store and perform program instructions. For example, the computer-readable recording media may be or include magnetic media such as hard disks, floppy disks, and magnetic tapes, optical media such as CD-ROMs and DVDs, magneto-optical media such as floptical disks, ROM, RAM, or flash memory. The program instructions may include not only machine language codes such as that generated by a compiler, but also high-level language codes that can be executed by a computer through an interpreter.

As the positive electrode active material, a compound capable of reversibly intercalating/deintercalating lithium (e.g., a lithiated intercalation compound) may be used. For example, a composite oxide of lithium or a metal such as at least one of cobalt, manganese, nickel, and combinations thereof may be used.

The composite oxide may be or include a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by at least any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is or includes at least Ni, Co, Mn, or a combination thereof; X is or includes at least Al, Ni, Co, Mn, Cr, Fe, Mg, Sr, V, a rare earth element, or a combination thereof; D is or includes at least O, F, S, P, or a combination thereof; G is or includes at least Al, Cr, Mn, Fe, Mg, La, Ce, Sr, V, or a combination thereof; and L1 is or includes at least Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is about 90 wt % to about 99.5 wt % on the basis of 100 wt % of the positive electrode active material layer, and the content of the binder and the conductive material is about 0.5 wt % to about 5 wt % and about 0.5 wt % to about 5 wt %, respectively, on the basis of 100 wt % of the positive electrode active material layer.

The current collector may be or include aluminum (Al) but is not limited thereto.

The negative electrode active material may include a material capable of reversibly intercalating/deintercalating at least one of lithium ions, lithium metal, an alloy of lithium metal, a material capable of being doped and undoped with lithium, or a transition metal oxide.

The material capable of reversibly intercalating/deintercalating lithium ions may be or include a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, or sintered coke.

A Si-based negative electrode active material or a Sn-based negative electrode active material may be used as the material capable of being doped and undoped with lithium. The Si-based negative electrode active material may be or include silicon, a silicon-carbon composite, SiOx (0<x<2), a Si-based alloy, or a combination thereof.

The silicon-carbon composite may be or include a composite of silicon and amorphous carbon. According to an embodiment, the silicon-carbon composite may be in the form of a silicon particle and amorphous carbon coated on the surface of the silicon particle.

The silicon-carbon composite may include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, copper foil, nickel foil, stainless steel foil, titanium foil, nickel foam, copper foam, conductive metal-coated polymer substrate, or combinations thereof may be used.

An electrolyte for a lithium secondary battery may include a non-aqueous organic solvent and a lithium salt.

The non-aqueous organic solvent may constitute a medium through which ions involved in the electrochemical reaction of the battery can move.

The non-aqueous organic solvent may be or include a carbonate-based, an ester-based, an ether-based, a ketone-based, an alcohol-based solvent, an aprotic solvent, or combinations thereof.

Depending on the type of lithium secondary battery, a separator may be present between the first electrode plate (e.g., the negative electrode) and the second electrode plate (e.g., the positive electrode). As the separator, at least polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles such as Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof but is not limited thereto.

The organic material and the inorganic material may be mixed in one coating layer or may be in the form of a coating layer containing an organic material and a coating layer containing an inorganic material that are laminated on each other.

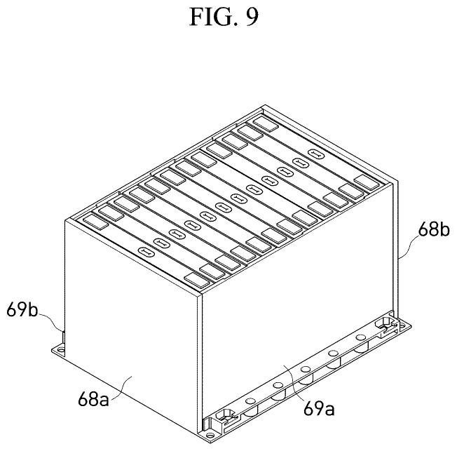

FIG. 9 is an illustration of a secondary battery module in which secondary batteries manufactured according to the present disclosure are arranged. As used for example in electric vehicles, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in arrangement (direction) and number to obtain desired voltage and current specifications.

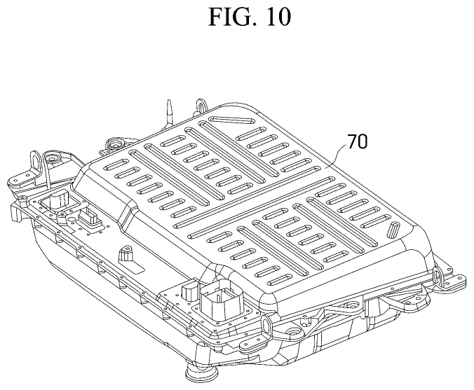

FIG. 10 is an illustration schematically showing the configuration of a battery pack 70. Referring to FIG. 10, a battery pack 70 may include an assembly to which individual batteries are electrically connected, and a pack housing accommodating the same. For convenience of illustration, components including a bus bar, a cooling unit, external terminals for electrically connecting batteries, etc., are not shown.

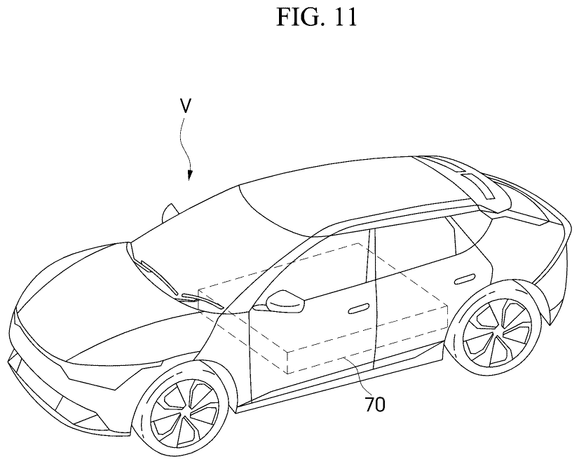

The battery pack 70 may be mounted on (or in) a vehicle. The vehicle may be, for example, an electric vehicle, a hybrid vehicle, a plug-in hybrid vehicle, and the like. The vehicle may be a four-wheeled vehicle or a two-wheeled vehicle but is not limited thereto. FIG. 11 shows a vehicle V which includes the battery pack 70 shown in FIG. 10 on the lower body thereof. The vehicle V may operate by (e.g., may be powered by) receiving power from the battery pack 70.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A system for preventing reuse of a battery monitoring system (BMS), the system comprising:
a battery monitoring unit configured to monitor specifications of a battery;
a cell replacement determination unit configured to determine whether a cell has been replaced in a battery pack based monitoring of the specifications of the battery; and
a permanent failure mode entry unit configured to determine whether to enter into a permanent failure mode for the battery pack based on determination of whether the cell has been replaced.

2. The system as claimed in claim 1, wherein the battery monitoring unit is configured to monitor a capacity of the battery or an internal resistance of the battery, upon wake-up of the battery pack after shutdown.

3. The system as claimed in claim 2, wherein the cell replacement determination unit is configured to determine that the cell has been replaced when the capacity of the battery is changed to equal to or greater than a maximum reference capacity or less than the maximum reference capacity.

4. The system as claimed in claim 2, wherein the cell replacement determination unit is configured to determine that the cell has been replaced when the internal resistance is changed to equal to or greater than a maximum reference resistance or less than the maximum reference resistance.

5. The system as claimed in claim 2, wherein the cell replacement determination unit is configured to determine that the cell has been replaced when the capacity of the battery is increased to equal to or greater than a reference capacity and the internal resistance is increased to equal to or greater than a reference resistance.

6. The system as claimed in claim 2, wherein the cell replacement determination unit is configured to determine that the cell has been replaced when the capacity of the battery is decreased to less than or equal to a reference capacity and the internal resistance is decreased to less than or equal to a reference resistance.

7. The system as claimed in claim 1, wherein the cell replacement determination unit is configured to receive an exception condition and prohibit entry into the permanent failure mode.

8. A method of preventing reuse of a battery monitoring system (BMS), the method comprising steps of:
(a) monitoring specifications of a battery;
(b) determining whether a cell has been replaced in a battery pack based on the step (a); and
(c) determining whether to enter into a permanent failure mode based on the step (b).

9. The method as claimed in claim 8, wherein the step (a) comprises monitoring a capacity of the battery or an internal resistance of the battery.

10. The method as claimed in claim 9, wherein the step (b) comprises determining that the cell has been replaced when the capacity of the battery is changed to equal to or greater than a maximum reference capacity or less than the maximum reference capacity.

11. The method as claimed in claim 9, wherein the step (b) comprises determining that the cell has been replaced when the internal resistance of the battery is changed to equal to or greater than maximum reference resistance or less than the maximum reference resistance.

12. The method as claimed in claim 9, wherein the step (b) comprises determining that the cell has been replaced when the capacity of the battery is increased to equal to or greater than a reference capacity and the internal resistance of the battery is increased to equal to or greater than a reference resistance.

13. The method as claimed in claim 9, wherein the step (b) comprises determining that the cell has been replaced when the capacity of the battery is decreased to less than or equal to a reference capacity and the internal resistance of the battery is decreased to less than or equal to a reference resistance.

14. The method as claimed in claim 8, wherein the step (c) comprises:
receiving an exception condition based on a cycle count or a runtime; and
prohibiting entry into a permanent failure mode.

15. An apparatus for preventing reuse of a battery monitoring system (BMS), the apparatus comprising:
an input interface device configured to receive information on specifications of a battery, the specifications comprising a capacity of the battery or an internal resistance of the battery;
a memory configured to store information related to a program determining whether a cell has been replaced by an unauthorized entity based on the information on the specifications of the battery; and
a processor configured to execute the program,
wherein the processor is configured to determine whether the cell has been replaced based on a maximum reference capacity, a reference capacity, a maximum reference resistance, or a reference resistance.

16. The apparatus as claimed in claim 15, wherein the processor is configured to determine that the cell has been replaced when the capacity of the battery is changed to equal to or greater than the maximum reference capacity or less than the maximum reference capacity.

17. The apparatus as claimed in claim 15, wherein the processor is configured to determine that the cell has been replaced when the internal resistance of the battery is changed to equal to or greater than the maximum reference resistance or less than the maximum reference resistance.

18. The apparatus as claimed in claim 15, wherein the processor is configured to determine that the cell has been replaced when the capacity of the battery is increased to equal to or greater than the reference capacity and the internal resistance of the battery is increased to equal to or greater than the reference resistance.

19. The apparatus as claimed in claim 15, wherein the processor is configured to determine that the cell has been replaced when the capacity of the battery is decreased to less than or equal to the reference capacity and the internal resistance of the battery is decreased to less than or equal to the reference resistance.

20. The apparatus as claimed in claim 15, wherein the processor is configured to determine to enter into a permanent failure mode based on whether the cell has been replaced, and configured to receive an exception condition on the permanent failure mode.
